(19) United States
(12) Patent Application Publication
(10) Pub. No.: US 2025/0309816 A1
(43) Pub. Date: Oct. 2, 2025

(54) CONNECTING ASSEMBLY AND PHOTOVOLTAIC BRACKET

(71) Applicant: Mokun Renewable Technologies Co., Ltd., Shanghai (CN)

(72) Inventors: Jiabao GUO, Shanghai (CN); Xiao LIU, Shanghai (CN)

(21) Appl. No.: 18/864,825

(22) PCT Filed: May 18, 2023
(86) PCT No.: PCT/CN2023/094996

§ 371 Date: Nov. 11, 2024

(30) Foreign Application Priority Data
May 20, 2022 (CN) 202221330762.4

(51) Int. Cl. H02S 20/32; F16B 7/04

(52) U.S. Cl. CPC H02S 20/32; F16B 7/0426

(57) ABSTRACT

A connecting assembly for connecting two adjacent main beam sections of a photovoltaic support, where the main beam sections define an axial direction and a width direction; an axial gap is formed between the two adjacent main beam sections; and the connecting assembly comprises two hoop members tightly holding the two adjacent main beam sections from an upper side and a lower side, respectively. The connecting assembly further comprises a plurality of limiting fasteners. The two hoop members each have an attaching wall that is tightly attached to an upper surface and a lower surface of the two adjacent main beam sections, respectively; a plurality of through holes distributed along the width direction are disposed on the attaching wall; and each limiting fastener in the plurality of limiting fasteners is disposed to pass through the axial gap to connect the corresponding through holes of the two hoop members in a penetrating manner, so that the two hoop members clamp the two adjacent main beam sections from the upper side and the lower side, respectively. A photovoltaic support comprising the connecting assembly described above. When the connecting assembly is used for connecting the two main beam sections, when the main beam rotates, angle deviation is less prone to occurring between the two main beam sections, and the connecting assembly can be prevented from sliding laterally.

### TECHNICAL FIELD

The present disclosure relates to a connecting assembly for connecting two adjacent main beam sections of a photovoltaic support, and also to a photovoltaic support.

### BACKGROUND ART

In photovoltaic support with steel structures, particularly photovoltaic tracking system support, square steel pipes are typically used as the main beam of the support. In actual applications, due to processing conditions and material length limitations, the main beam is typically spliced from several sections of square steel pipes or round steel pipes, and two sections of steel pipes need to be spliced and fixed with connectors. There is typically no limiting and blocking between such connectors and the main beam along the direction of the axis of the main beam. Axial sliding is solely prevented by the friction generated by the clamping of the connector and the main beam, so it is difficult to maintain.

A photovoltaic array support and a connecting assembly thereof are disclosed in Patent CN210669972U published in China. In the connecting assembly described above, a non-sliding stopper is clamped between an upper hoop member and a lower hoop member to effectively prevent the connector from sliding.

However, during the actual application of the connecting assembly described above, the inventors discovered that when the main beam rotates and thus transmits torque between two main beam sections, the connectors distort and deform, the cross-section of the two main beam sections cannot be fully aligned, and a certain degree of torsion occurs, i.e., angle deviation occurs between the two main beam sections.

Therefore, improvements are needed to make it less prone for angle deviations between two main beam sections to occur.

### SUMMARY OF THE INVENTION

The object of the present disclosure is to provide a connecting assembly. When the connecting assembly is used for connecting two main beam sections, when the main beam rotates, angle deviation is less prone to occurring between the two main beam sections, and the connecting assembly can be prevented from sliding laterally.

The present disclosure provides a connecting assembly for connecting two adjacent main beam sections of a photovoltaic support, where the main beam sections define an axial direction and a width direction; an axial gap is formed between the two adjacent main beam sections; and the connecting assembly comprises two hoop members tightly holding the two adjacent main beam sections from an upper side and a lower side, respectively. The connecting assembly further comprises a plurality of limiting fasteners. The two hoop members each have an attaching wall that is tightly attached to an upper surface and a lower surface of the two adjacent main beam sections, respectively, a plurality of through holes distributed along the width direction are disposed on the attaching wall, and each limiting fastener in the plurality of limiting fasteners is disposed to pass through the axial gap to connect the corresponding through holes of the two hoop members in a penetrating manner, so that the two hoop members clamp the two adjacent main beam sections from the upper side and the lower side, respectively.

In an embodiment, the plurality of limiting fasteners is two limiting fasteners.

In an embodiment, the limiting fastener is a bolt.

In an embodiment, the line connecting the centers of the plurality of through holes of each hoop member is the centerline of the corresponding hoop member in the axial direction.

In an embodiment, each hoop member has a U-shaped hoop and two ear tabs, the U-shaped hoop having a bottom wall and two side walls constituting a U shape, the bottom wall constituting the attaching wall, each side wall having a distal end away from the bottom wall, the two ear tabs extending from the distal ends of the two side walls along the width direction and away from each other, respectively, each ear tab being disposed with a plurality of connection holes distributed along the axial direction. The two hoop members connect the corresponding connection holes of the two hoop members in a penetrating manner through connecting fasteners to tightly hold the two adjacent main beam sections from the upper side and the lower side, respectively.

In an embodiment, each hoop member has a centerline in the axial direction. The plurality of connection holes of the ear tabs of each hoop member is distributed symmetrically relative to the centerline.

In an embodiment, the plurality of connection holes is an even number of connecting holes.

In an embodiment, the connection holes and the through holes are the same size.

The present disclosure provides a photovoltaic support comprising two adjacent main beam sections, and further comprising the aforementioned connecting assembly, where the connecting assembly connects the two adjacent main beam sections.

In an embodiment, each limiting fastener in the plurality of limiting fasteners of the connecting assembly abuts the end faces of the two adjacent main beam sections on both sides, respectively.

When connecting the two main beam sections using the connecting assembly, the plurality of limiting fasteners may pass through the axial gap between the two adjacent main beam sections and the through holes disposed on the attaching wall of the two hoop members, so that the two hoop members tightly press the main beam sections from the upper and lower sides, respectively. Moreover, the plurality of limiting fasteners distributed along the width direction may also be located between the two main beam sections in the axial direction, and securely limits the end faces of the main beam sections. Therefore, when the main beam rotates, torsion of the two main beam sections and angle deviation between the two main beam sections are less prone to occur, and the connecting assembly may be prevented from sliding laterally.

### DESCRIPTION OF ACCOMPANYING DRAWINGS

The aforementioned and other characteristics, nature and advantages of the present disclosure will be further highlighted below in conjunction with the following accompanying drawings and description of examples, wherein

FIG. 1 is a perspective view showing an exemplary connecting assembly connecting two main beam sections.

FIG. 2 is a perspective view of an exemplary hoop member.

FIG. 3 is a schematic view of two hoop members mated to each other.

FIG. 4 is a schematic diagram showing two main beam sections and a lower hoop member.

FIG. 5 is a schematic diagram showing one main beam section and a lower hoop member.

### SPECIFIC EMBODIMENTS

The present disclosure will be further described below with specific embodiments and accompanying drawings. More details are described in the following description to facilitate thorough understanding of the present disclosure. However, the present disclosure can obviously be embodied through different methods other than those described and those skilled in the art may promote and interpret this based on the actual application without deviating from the content of the present disclosure. Therefore, the scope of protection of the present disclosure should not be limited by the content of the specific embodiments.

For example, a first characteristic subsequently recorded in the Specification is formed above or on a second characteristic, may include embodiments in which the first characteristic and the second characteristic are formed by direct contact, and may also include embodiments in which additional characteristics are formed between the first characteristic and the second characteristic, so that there may be no direct contact between the first characteristic and the second characteristic. Further, when a first element is described by connecting or combining with a second element, the description includes embodiments in which the first element and the second element are directly connected or combined with each other, and also includes the addition of one or more other intervening elements to indirectly connect or combine the first element and the second element with each other.

Photovoltaic power generation has the characteristics of being clean, safe and emissions-free. It has become an emerging industry that is the key development of various countries and is one of the important ways to solve problems such as global energy shortages and environmental pollution. In photovoltaic power generation applications, photovoltaic support play a role in supporting, mounting and fixing photovoltaic modules, ensuring that photovoltaic modules in photovoltaic power stations are not subject to damage from the natural environment, such as wind, rain and snow, improving the efficiency of the power generation system and ensuring the normal service life of the power generation system. As mentioned earlier, the entire main beam of the photovoltaic support is typically spliced by several main beam sections using connectors.

When connecting two main beam sections, the main beam connectors for connecting the main beam sections are typically in the form of upper and lower two hoop members, and the connectors are centered at the joint positions of the two main beam sections. The main beam sections at the left and right ends are clamped with fasteners, thereby connecting the two main beam sections. Therefore, the center of the connectors, for example, in the north-south direction should always be kept at the joints of the two main beam sections, so that the bending moment and torque may be effectively transmitted between the two main beam sections.

However, there is no limiting and blocking between such connectors and the main beam along the direction of the axis of the main beam. Axial sliding is solely prevented by the friction generated by the clamping of the connector and the main beam section. When the main beam is at rest, such friction is fully capable of ensuring that no axial movement occurs between the connector and the main beam section. However, for fixed and adjustable or tracking support, during the rotation of the main beam, the connector is subjected to radial alternating torque of the two main beam sections. Therefore, during actual mounting, due to reasons such as insufficient tightening of the connector using the fastener or the loosening of the fastener caused by torsional vibration, the connector often slides along the axial direction in a single direction, which leads to the detachment of the main beam connection over time, damaging the structure. At the same time, when the main beam is rotated, the connector is subject to a lot of torque. When the contact area and clamping force between the connector and the main beam section are insufficient, the connector becomes deformed, the gap between the connector and the main beam section becomes larger, and the rotation angle of the two main beam sections deviates, causing torsion of the surface of the assemblies mounted on the main beam.

As a comparative example, methods such as welding a stopper or opening a screw hole on the main beam section may be employed to prevent the connector from sliding in the axial direction, for example, the anti-sliding stopper mentioned in prior art. However, opening a screw hole affects the strength of the main beam section and is also inconvenient to process. Disposing a stopper requires additional processing and increases costs. Moreover, the methods described above cannot solve the problem of distortion and deformation of the connector caused by the main beam during rotation, which causes angle deviation between two main beam sections.

The connecting assembly provided by the present disclosure has a plurality of limiting fasteners that pass through the axial gap between the two adjacent main beam sections to connect the through holes disposed on the attaching wall of the upper and lower two hoop members in a penetrating manner, so that the upper and lower two hoop members tightly press the main beam sections from the upper and lower sides, respectively, and may be located in the axial direction between the two main beam sections, thereby serving a positioning function and preventing angle deviation between the two main beam sections during torque transmission. Furthermore, the connecting assembly ensures that the connector does not slide in the axial direction without requiring any additional processing of the main beam sections.

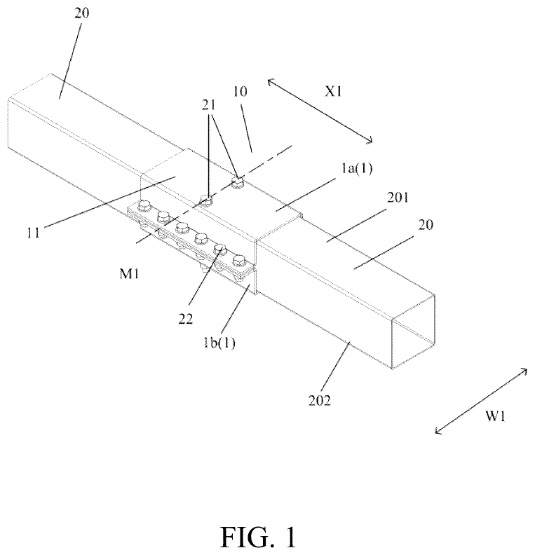

FIG. 1 exemplarily shows the connecting assembly 10 connecting two adjacent main beam sections 20 of the photovoltaic support.

For ease of description, the main beam sections 20 define an axial direction X1 and a width direction W1. There is an axial gap G1 between the two adjacent main beam sections 20.

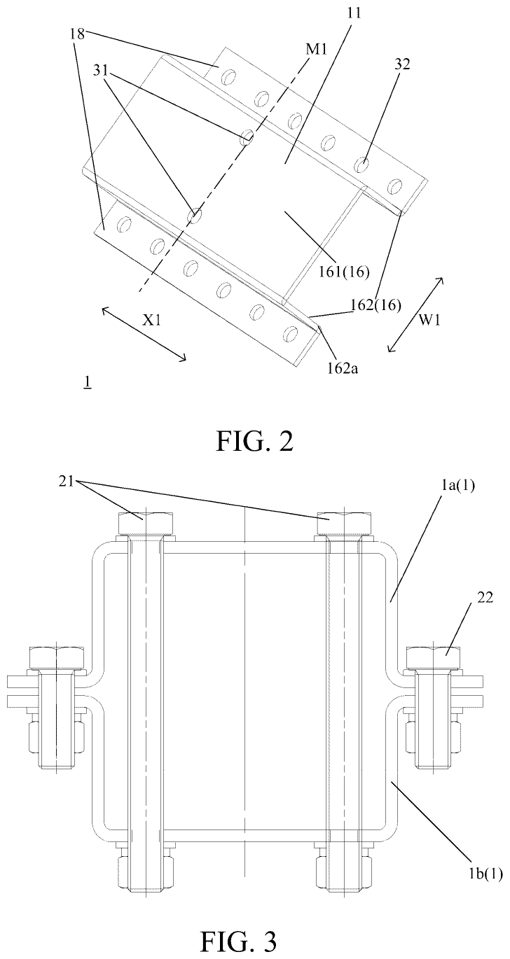

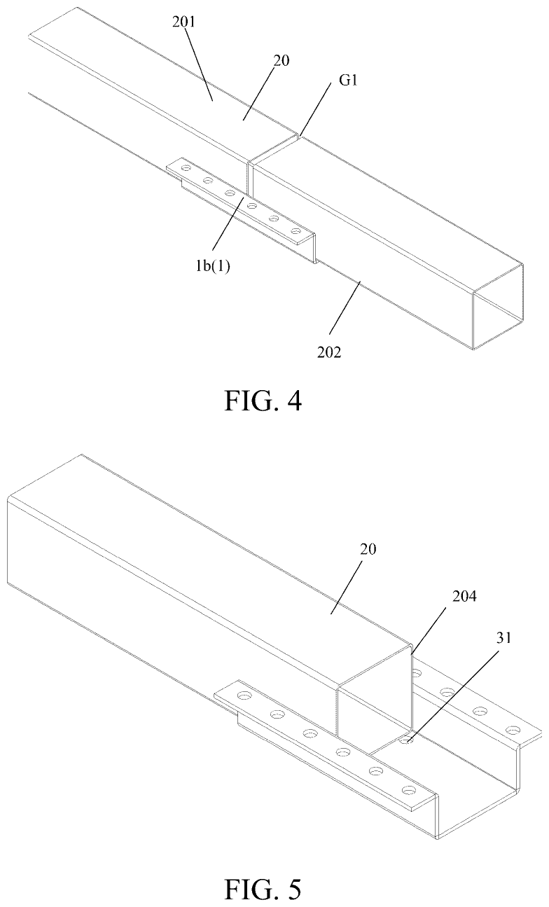

With reference to FIGS. 1 to 5, the connecting assembly 10 comprises two hoop members 1, i.e., an upper hoop member 1a and a lower hoop member 1b, which tightly hold the two adjacent main beam sections 20 from an upper side and a lower side, respectively. When not described separately, they are collectively referred to as hoop member 1, wherein FIG. 2 and FIG. 3 show an example construction in which one hoop member 1 and two hoop members 1 are mated to each other, respectively, and FIG. 4 and FIG. 5 show a schematic diagram of the exposed main beam section 20 when the upper hoop member 1a is removed.

The connecting assembly 10 further comprises a plurality of limiting fasteners 21. It should be understood that “plurality” in the text refers to more than two, including two, three, four, five, and the like. The limiting fasteners 21 and the connecting fasteners 22 that will be described later in the text may be, for example, bolts, screws, rivets, and the like.

The two hoop members 1 each have an attaching wall 11 that tightly holds the upper surface 201 and the lower surface 202 of the two adjacent main beam sections 20, respectively. That is, the attaching wall 11 of the upper hoop member 1a is tightly attached to the upper surface 201 of the two adjacent main beam sections 20, and the attaching wall 11 of the lower hoop member 1b is tightly attached to the lower surface 202 of the two adjacent main beam sections 20.

FIG. 2 exemplarily shows a perspective construction of the hoop member 1. In FIG. 2, a plurality of through holes 31 distributed along the width direction W1 are disposed on the attaching wall 11. With reference to FIGS. 1-5, each limiting fastener 21 in the plurality of limiting fasteners 21 is disposed to pass through the axial gap G1 to connect the corresponding through holes 31 of the two hoop members 1 in a penetrating manner, so that the two hoop members 1 clamp the two adjacent main beam sections 20 from the upper side and the lower side, respectively.

The two adjacent main beam sections 20 also constitute two adjacent main beam sections or two main beam sections spliced to each other in the entire main beam of the photovoltaic support.

The hoop member 1 may also be referred to as a main beam connector that splices two adjacent main beam sections 20 together, for example, it may be a hoop-shaped bending member.

The axial direction X1 defined by the main beam section 20 is also the direction of the axis or extension direction of the main beam or main beam section 20. The width direction W1 defined by the main beam section 20 is also the width direction of the hoop member 1, i.e., the direction perpendicular to the axial direction X1 and perpendicular to the opposite direction of the two hoop members 1. The axial gap G1 is also the gap between the two main beam sections 20 in the axial direction X1.

In the connecting assembly 10 described above, the limiting fasteners 21 sequentially pass through the attaching wall 11 located at the upper side of the upper hoop member 1a, the axial gap G1 between the two main beam sections 20, and the attaching wall 11 located at the lower side of the lower hoop member 1b to achieve fastening so that the upper hoop member 1a and the lower hoop member 1b tightly press the two main beam sections 20 from the upper and lower sides, respectively, and by disposing a plurality of limiting fasteners 21 distributed along the width direction W1 (i.e., at least two limiting fasteners 21) between the two main beam sections 20 in the axial direction X1, both sides may tightly abut the end face (or, cross-section) of the main beam section 20, respectively, thus serving a limiting function. When the entire main beam of the photovoltaic support is rotated, there is no relative torsion or angle deviation problem when torque is transmitted between the two main beam sections 20.

Moreover, the connecting assembly 10 described above does not require any additional processing of the main beam section 20, such as punching, and the like, does not affect the strength of the main beam section 20, and is capable of ensuring that the upper hoop member 1a and lower hoop member 1b do not slide in the axial direction.

It should be understood that spatial relational words such as “upper,” “lower,” and the like are used to describe the relationship between one element or characteristic and other elements or characteristics shown in the accompanying drawings. With reference to the direction in FIG. 3 for ease of description, typically, photovoltaic support are placed according to such upper and lower directions to support photovoltaic modules.

It should also be understood that unless specifically stated, the two directions referred to herein, namely “perpendicular,” “consistent,” “parallel,” and the like, do not need to meet strict mathematical angle requirements, but a range of tolerances is allowed, for example, a difference of within 20° from the mathematically required angle. By “along” a certain direction or “in a certain direction”, it refers to at least a component in the direction. Preferably, the included angle to the direction is within 45°. More preferably, the included angle is within 20° or even 5°.

As shown in FIG. 1, the plurality of limiting fasteners 21 may be two limiting fasteners 21. That is, there are only two limiting fasteners 21 in the connecting assembly 10. The use of two limiting fasteners 21 is capable of minimizing the number of limiting fasteners 21 used while preventing sliding and torsion.

As shown in FIG. 3, the limiting fasteners 21 may be bolts. For example, after the bolts that act as limiting fasteners 21 pass through the corresponding through holes 31 of the two hoop members 1, the bolt head is exposed at the upper side in FIG. 3, while the lower bolt rod is fastened by a mating nut. Standard parts such as bolts are simple and easy to use and low-cost.

It should be understood that the use of specific words in the text to describe embodiments of the present disclosure, such as “an embodiment,” “another embodiment,” and/or “some embodiments” refer to a certain characteristic, structure, or feature associated with at least one embodiment of the present disclosure. Thus, it should be emphasized and noted that references to “an embodiment” or “another embodiment” in the Specification two or more times at different locations do not necessarily refer to the same embodiment. Further, certain characteristics, structures, or features in one or more embodiments of the present disclosure may be appropriately combined.

As shown in FIG. 2, the line connecting the centers of the plurality of through holes 31 of each hoop member 1 may be the centerline M1 of the corresponding hoop member 1 in the axial direction X1. That is, the through holes 31 are located in the center position of the hoop member 1 in the axial direction X1, which may have better pressing effects.

As shown in FIG. 2, each hoop member 1 may have a U-shaped hoop 16 and two ear tabs 18. The U-shaped hoop 16 may have a bottom wall 161 and two side walls 162 constituting the U shape. The bottom wall 161 constitutes the aforementioned attaching wall 11 and each side wall 162 has a distal end 162a away from the bottom wall 161. The two ear tabs 18 may extend away from each other along the width direction W1 from the distal end 162a of the two side walls 162, respectively. Each ear tab 18 may be disposed with a plurality of connection holes 32 distributed along the axial direction X1.

With reference to FIGS. 1 to 5, the two hoop members 1 may connect the corresponding connection holes 32 of the two hoop members 1 in a penetrating manner through connecting fasteners 22 to tightly hold the two adjacent main beam sections 20 from the upper side and the lower side, respectively.

Taking the above hoop member 1a as an example, the shape of the upper hoop member 1a is roughly as follows. The two ends of the upper hoop member 1a are bent downwards, the two sides are bent downwards and then bent towards the two ends, respectively. There is a row of bolt holes at the edge and there are two screw holes parallel to the short edge in the middle of the hoop member.

As shown in FIG. 2, as previously described, each hoop member 1 has a centerline M1 in the axial direction X1. The aforementioned plurality of connection holes 32 of the ear tabs 18 of each hoop member 1 may be distributed symmetrically relative to the centerline M1.

As shown in FIG. 2, the aforementioned plurality of connection holes 32 may be an even number of connection holes 32, for example, in the drawing, each ear tab 18 has six connection holes 32.

As shown in FIG. 2, the connection holes 32 and through holes 31 are the same size. In this way, holes may be made using the same hole making apparatus, and the limiting fasteners 21 and the connecting fasteners 22 may also be the same, for example, bolts of the same specification.

Exemplarily, with reference to FIGS. 1-3, two hoop members 1 may be mounted symmetrically when the hoop member 1 is mounted to connect the main beam sections 20. One member is mounted above the connection of the main beam, i.e. the upper hoop member 1a. One member is mounted below the connection of the main beam, i.e. the lower hoop member 1b. The connection holes 32 of the two hoop members 1 are aligned in position, and the through holes 31 in the middle of the hoop member 1 are aligned with the slit at the connection of the main beam section 20, that is, the axial gap G1. The main beam section 20 has a slit at the joint so that the two bolts that serve as the two limiting fasteners 21 in FIG. 1 are able to pass through the through holes 31 in the middle of the two hoop members 1. The hoop member 1 may be fastened with bolts. The bolts on both sides (serving as connecting fasteners 22) and the two bolts in the middle (serving as limiting fasteners 21) sequentially pass through the bolt hole of the upper hoop member 1a and the bolt hole of the lower hoop member 1b, and are tightened and fixed.

The present disclosure further comprises a photovoltaic support. The photovoltaic support comprises two adjacent main beam sections 20. The photovoltaic support may further comprise the aforementioned connecting assembly 10. The connecting assembly 10 may connect the two adjacent main beam sections 20.

With reference to FIGS. 1-5, each limiting fastener 21 in the plurality of limiting fasteners 21 of the connecting assembly 10 may abut the end faces 204 of the two adjacent main beam sections 20 on both sides, respectively (shown in FIG. 5). That is, both sides of the limiting fastener 21 in the axial direction X1 directly contact the end faces of the two main beam sections 20 opposite each other, respectively.

In the connecting assembly and photovoltaic support described above, when the main beam causes the hoop member to slide radially to one side under the action of alternating torque, the limiting fastener in the middle of the hoop member hinders the sliding of the hoop member to the two sides, and the sliding of the hoop member to either side is blocked by the end face of the main beam, thus preventing the sliding of the hoop member. In addition, the connecting assembly described above has a simple structure, is easy to manufacture and mount, and is low-cost and reliable.

With the promotion and application of flat single-axis tracking technology in the construction of photovoltaic power stations, connecting assemblies comprising hoop members is an effective measure to improve the performance of flat single-axis tracking support and has broad application prospects in the construction of photovoltaic power stations in the future.

Although preferred examples of the present disclosure are disclosed above, they are not used to limit the present disclosure and those skilled in the art may make changes and amendments without departing from the spirit and scope of the present disclosure. Therefore, as long as the content does not depart from the technical solution of the present disclosure, any amendments, equivalent changes and modifications to the above examples based on the technical essence of the present disclosure fall into the scope of protection defined in the Claims of the present disclosure.

1. A connecting assembly for connecting two adjacent main beam sections of a photovoltaic support, where the main beam sections define an axial direction and a width direction; an axial gap is formed between the two adjacent main beam sections; and the connecting assembly comprises two hoop members tightly holding the two adjacent main beam sections from an upper side and a lower side, respectively, characterized in that the connecting assembly further comprises a plurality of limiting fasteners;
The two hoop members each have an attaching wall that is tightly attached to an upper surface and a lower surface of the two adjacent main beam sections, respectively, a plurality of through holes distributed along the width direction are disposed on the attaching wall, and each limiting fastener in the plurality of limiting fasteners is disposed to pass through the axial gap to connect the corresponding through holes of the two hoop members in a penetrating manner, so that the two hoop members clamp the two adjacent main beam sections from the upper side and the lower side, respectively.

2. The connecting assembly according to claim 1, characterized in that the plurality of limiting fasteners is two limiting fasteners.

3. The connecting assembly according to claim 1, characterized in that the limiting fasteners are bolts.

4. The connecting assembly according to claim 1, characterized in that the line connecting the centers of the plurality of through holes of each hoop member is the centerline in the axial direction of the corresponding hoop member.

5. The connecting assembly according to claim 1, characterized in that each hoop member has
a U-shaped hoop having a bottom wall and two side walls constituting a U shape, the bottom wall forming the attaching wall, each side wall having a distal end away from the bottom wall;
two ear tabs extending from the distal ends of the two side walls along the width direction and away from each other, respectively, each ear tab being disposed with a plurality of connection holes distributed along the axial direction;
The two hoop members connect the corresponding connection holes of the two hoop members in a penetrating manner through connecting fasteners to tightly hold the two adjacent main beam sections from the upper side and the lower side, respectively.

6. The connecting assembly according to claim 5, characterized in that each hoop member has a centerline in the axial direction;
The plurality of connection holes of the ear tabs of each hoop member is distributed symmetrically relative to the centerline.

7. The connecting assembly according to claim 5, characterized in that the plurality of connection holes is an even number of connection holes.

8. The connecting assembly according to claim 5, characterized in that the connection holes and the through holes are the same size.

9. A photovoltaic support comprising two adjacent main beam sections, characterized in that it further comprises a connecting assembly according to any one of claims 1 to 8, and the connecting assembly connects the two adjacent main beam sections.

10. The photovoltaic support according to claim 9, characterized in that each limiting fastener in the plurality of limiting fasteners of the connecting assembly abuts the end faces of the two adjacent main beam sections on both sides, respectively.
